(19) United States
(12) Patent Application Publication
(10) Pub. No.: US 2004/0108779 A1
(43) Pub. Date: Jun. 10, 2004

(54) Electric motor for a pump drive

(76) Inventors: Axel Boettger, Dresden (DE); Ullrich Kreiensen, Deisslingen (DE); Helmut Hans, Sankt Georgen (DE); Manfred Rauer, Sankt Georgen (DE)

Correspondence Address: DUANE MORRIS LLP, Suite 700, 1667 K Street, N.W., Washington, DC, 20006, US

(21) Appl. No.: 10/687,834

(22) Filed: Oct. 20, 2003

(30) Foreign Application Priority Data
Nov. 22, 2002 (DE) 102 54 670.3

(51) Int. Cl. H02K 1/04; F04B 17/00; F04B 35/04

(52) U.S. Cl. 310/89; 310/43; 417/423.1; 417/423.14

(57) ABSTRACT

Electrical motor for a pump drive, with a stator and a rotor for driving a pump impeller, the stator being embedded in a plastic body and the plastic body forming a chamber together with the stator in which the rotor is received, the chamber being closed at one shaft end of the rotor and the rotor being connected at the opposite (second) shaft end to the pump impeller.

### FIELD OF THE INVENTION

The invention relates to an electric motor for a pump drive with a stator and a rotor for driving a pump impeller.

### BACKGROUND OF THE INVENTION

It is well known to design electric motors for pump drives as so-called canned motors. A canned motor is a wet-rotor motor in which the rotor is surrounded by a metal sleeve-closed on one side and surrounded by the pumping medium. The cup shaped metal sleeve protects the stator, phase windings and motor electronics which may be contained in the motor housing from the pumping medium. The cup shaped sleeve is positioned in the air gap between the rotor and stator. The motor shaft protrudes from the open end of the cup shaped sleeve and is fitted to a pump impeller. Examples of canned motors are described in DE 38 18 532 A1, DE 44 38 132 A1, DE199 07 555 A1, DE41 29 590 A1, EP0 963 029 A2.

Electric motors for driving feed pumps are known in the prior art in which the motors, for example, are completely separated from the pumping medium by a sealed bearing and a shaft seal. In this case the motor is arranged in an enclosed and sealed housing from which the shaft protrudes and is fitted to the pump impeller. In order to seal the shaft a roller bearing in combination with a rotary shaft seal for example can be used, serving as a seal to separate the motor from the pumping medium. Such motors have the disadvantage that the seals generate additional frictional loss and are subject to malfunction. The seal is frequently one of the major weak points of the pump drive, with pumping medium penetrating the motor if the seal is damaged, eventually leading to motor destruction.

One object of the invention is to provide an electric motor for a pump which is designed as a wet-rotor motor. Wet-rotor motors, like canned motors, can be designed without the shaft seal system which is susceptible to malfunction. Here the pumping medium circulates not only in the pump, but also in one part of the motor which part then, must be sealed in relation to its surroundings. The motor according to the invention is intended to ensure a reliable separation of the part of the motor chamber in which the pumping medium circulates from other parts of the motor, particularly from the stator and the electronics.

More generally, it is also an object of the invention to provide an electric motor to drive a pump which is small, can be manufactured inexpensively and saves energy when operated. A brushless direct current (DC) motor should preferably be utilized, although the invention is not limited to this kind of motors.

### SUMMARY OF THE INVENTION

This function is achieved by an electric motor including the features of claim 1.

Advantageous embodiments of the invention are specified in the dependent claims.

According to the invention, the stator is enclosed in a plastic body in order to separate it from and protect it against the pumping medium. Preferably the stator core and phase windings are completely enclosed by the plastic body, so that only the connection wires of the phase windings protrude from the plastic body itself. The plastic body is preferably manufactured by injection molding. The invention thus forms an enclosed, electromagnetic system embedded in the plastic body, the plastic body preferably is designed so that a chamber is provided in which the rotor is placed which chamber is closed on one of the end faces of the rotor. On the other end face the rotor is mounted to the pump drive. The connection wires of the phase windings preferably should protrude from the plastic body at the opposite side of the closed end of the chamber in which the rotor is placed. This ensures that the chamber in which the rotor is placed is, in fact, completely closed and the pumping medium cannot creep through any possible gaps or cracks.

The plastic body preferably should be designed such that further motor components (e.g. two bearing seats for supporting the rotor shaft) can be incorporated.

Furthermore, the plastic body can also be designed so that means for fitting the motor can directly be molded onto the plastic body (e.g. a motor flange or other fitting means).

A preferred embodiment of the invention has the stator integrated in a plastic body by injection molding. This involves production of the chamber closed on one side as a single component in one molding process. The function of the plastic body is to seal the drive system of the feed pump against the pumping medium to the outside and to protect the feed pump against environmental influences. Additionally, the plastic body provides means for precise positioning and fixing of the connection wires of the phase windings which protrude from the plastic body.

The rotor with motor shaft and the pre-assembled bearings can be pushed into the chamber formed in the plastic body from its open end face, whereby the axial positioning and fixing of the motor shaft and the rotor is done by a positive locking with a pump housing to which the plastic body can be affixed.

In another embodiment of the invention, the plastic body provides a chamber open on both sides in which the stator is located. One of the end faces of the chamber is closed by a cap produced from the same material (although another material may be used).

### BRIEF DESCRIPTION OF THE DRAWINGS

The invention is explained in greater detail below based on a preferred embodiment and with reference to the drawings, wherein:

FIG. 1 shows a cross-sectional view of a first embodiment of the electric motor according to the invention;

FIG. 2 shows a cross-sectional view of a second embodiment of the electric motor according to the invention;

FIG. 3 shows an dismantled perspective view of the electric motor according to the invention in accordance with the first embodiment;

FIGS. 4A and 4B show a side view and a perspective view of the plastic body used in the electric motor according to the invention;

FIGS. 5A and 5B show a dismantled view and a perspective view of the rotor used in the electric motor according to the invention.

### DETAILED DESCRIPTION OF PREFERRED EMBODIMENT

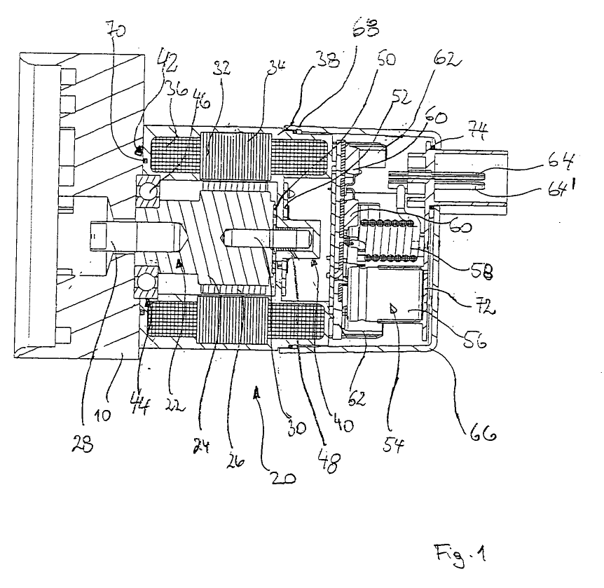

FIG. 1 illustrates a cross-sectional view of an electric motor according to a first preferred embodiment of the invention. The electric motor illustrated in FIG. 1 is a brushless DC motor, although the invention can generally be used with any electric motor being designed as canned or wet-rotor motors. A pump house is generally designated as 10 in FIG. 1. The pump housing 10 holds a pump impeller (not illustrated) and has an inlet and outlet for the pumping medium. No further details of the pump itself are described here, as feed pumps are commonly known from the prior art. The electric motor according to the invention is generally designated as 20. It comprises a rotor 22 with a coil flux guide (yoke) 24 and a permanent magnet 26. Shaft stub ends 28, 30 are connected with the coil flux guide 24 at both shaft ends of the coil flux guide 24 (the bond being resistant to torsion). The shaft stub ends 28, 30 are preferably hardened steel pins, but can be manufactured from any other suitable material. A continuous shaft (not illustrated) on which the rotor coil flux guide is mounted in the usual manner can be fitted as an alternative to the illustrated embodiment.

The electric motor 20 also includes a stator 32 with a stator body 34 and phase windings 36. The stator body 34 can be designed as a laminated sheet stack.

The entire stator 32 is enclosed in an injection-molded plastic material which forms a plastic body 38. FIG. 1 indicates that the plastic body 38 forms a chamber for receiving the stator 22, the first shaft end 40 of which is enclosed (see right of figure). The chamber formed by the plastic body 38 is open at the second opposite shaft end 42. A bearing seat 44 is formed at the second shaft end 42 which holds a roller bearing 46 (preferably a ball bearing). The roller bearing 46 supports the rotor 22 in the plastic body 38.

A journal bearing (or hydrodynamic fluid bearing) is fitted between the shaft stub end 30 and the sleeve 48 at the first shaft end 40 to support the rotor 22, the sleeve being integrated in the shaft end 40 of the plastic body 38. It is advantageous if the shaft stub end 30 is manufactured from hardened steel when forming this journal bearing. Hydrodynamic fluid bearings are known in the prior art, and examples are described in U.S. Pat. No. 4,934,8636. The shaft can consist of another softer material if other types of bearing are utilized.

A magnetic disk 50 is mounted on the shaft end of the rotor 22 at the first shaft end 40 which acts as a signal transducing sensor for recording the position and speed of the rotor 22. A sensor PCB 52 is fitted opposite the magnetic disk 50 outside the plastic body 38 which can support Hall elements or other sensors for recording the rotational position and/or speed of the rotor relative to the magnetic disk 50.

An electronic module is fitted outside the first shaft end 40 of the plastic body 38 which is generally designated 54. This is used for electric motor 20 control and power supply. The electronic module 54 can include a buffer capacitor 56, interference suppressor 58, FET power transistors 60 and connection pins 62 for establishing electrical connections for motor phases. These take the form of metal lugs in the illustrated embodiment. The electronic module 54 also encompasses connection pins 64, 64′ which protrude outwards for connecting the electric motor 20 to a positive and negative power supply connection, one of the connection pins 64 being directly connected to the interference suppressor 38 (as shown in FIG. 1).

The electronic module is enclosed between the plastic body 38 and a cover 66, the cover 66 being sealed against the plastic body 38 with an O-ring 68 or another suitable seal. A further O-ring seal 70 is fitted between the plastic body 38 and the pump housing 10. A supporting component 72 is fitted in the cover 66 which aids exact positioning and support of various components in the electronic module (e.g. connection pins 64, 64′, capacitors 56 and similar). The supporting component 72 is sealed against the cover 66 with a further O-ring seal 74.

As mentioned, the stator 32 is completely integrated in the plastic body 38 by injection molding, the plastic body being closed at the first shaft end 40. The plastic body 38 closed on one side should preferably be manufactured as a single component in one injection molding procedure. The plastic body 38 insulates the entire electromechanical module against the medium conveyed by the pump and protects the stator module 32 against any environmental influences. The stator 32, stator body 34 and phase winding 36 circuit is preferably completed before being encased in the molding, with only the phase connections (or three connections in the case of a three-phase motor) protruding from the plastic body 38 (but not the individual winding wires 36).

According to the invention, it is preferable that other functions be integrated in the plastic body 38 (e.g. bearing seats and fixing elements for connecting the plastic body 38 to the pump housing 10). The plastic body 38 can also be used to position and fix the sensor PCB 52 and the electronic module 54 (or parts thereof). It can also be beneficial if metal parts are integrated in the plastic body 38 (particularly in its exterior) in order to shield the motor against outward influences. Metal particles, a metal grid or similar can be integrated directly in the plastic body 38 during the injection molding process.

The main function of the plastic body 38, however, is a complete sealed separation of the chamber for receiving the rotor 22 which is accessible to the pumping medium from all electromechanical components.

In order to compare the electric motor according to the invention with known canned motors of the prior art, it is necessary to consider the plastic body 38 in which the stator is embedded as assuming the function of the can and, simultaneously, at least partially acting as a housing for positioning other electric motor components and for fixing the electric motor 20 to the pump housing 10. The plastic body also protects the stator module against exterior environmental influences.

The invention can be used on both internal rotor and external rotor motors.

The plastic body 38 could also replace the pump housing 10 (or part thereof) in any further embodiment of the invention by connecting the pump impeller (not illustrated) directly to the rotor 22 and receiving it in the plastic body 38 (i.e. a housing for the pump impeller can be joined directly to the plastic body 38 through injection molding or designed as a single part together with the plastic body).

In the embodiment illustrated in FIG. 1, the coil flux guide (yoke) 24 of the rotor 22 at least partially takes over the function of the shaft, so it is preferable that hardened steel pins be used as shaft stub ends 28, 30. Such hardened steel pins are particularly practical when designing one or both bearings as journal bearings (as is the case with 48). Hardened pins are available commercially as ready-made components. A continuous shaft can, of course, be used as an alternative.

The embodiment of the coil flux guide 24 of in FIG. 1 has the further advantage of facilitating the integration of ball bearings (such as bearing 46) in the coil flux guide 24. The coil flux guide 24 can, in particular, be designed with an exterior diameter which allows adaptation of the bearing size to the internal diameter of the plastic body 38. The same function would require that a shaft with an extremely large diameter be provided if a continuous shaft with a fitted coil flux guide is used.

The rotor 22 with the coil flux guide 24 and permanent magnet 26 is designed with as smooth as possible a surface to avoid or reduce as completely as possible any disturbance of the pumping medium in the chamber enclosed by the plastic body 38 upon rotation of the rotor.

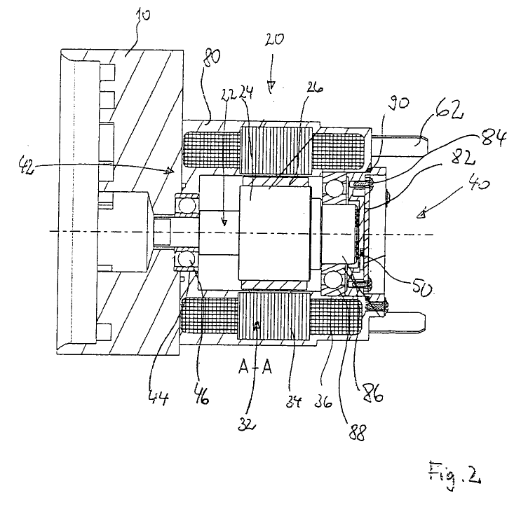

FIG. 2 illustrates a sectional view of an alternative electric motor embodiment in accordance with the invention. The same or similar components (as in FIG. 1) bear the same reference numbers and are not explained here again. The electronic module 54 and cover 66 are not shown in FIG. 2. They can be designed as illustrated in FIG. 1 or differently.

The embodiment in FIG. 2 mainly differs from FIG. 1 in that the stator 32 is encased in an injection-molded plastic body 80 which is open at both shaft ends 40, 42. The plastic body 80 is closed by a cover 82 at the first shaft end 40 (which should preferably also be plastic). A sealed connection of the cover 82 and plastic body 80 is realized with screws 84 or another fixing agent. The cover 82 is sealed against the plastic body 38 with an O-ring 90 or another suitable sealing.

Furthermore, the rotor 22 in FIG. 2 is supported in the plastic body 30 on a shaft 86 by roller bearing 46 and a further roller bearing 88.

On the embodiment in FIG. 2, the motor shaft 86 with the pre-mounted rotor 20 and bearings 46, 86 can be pushed into the plastic body 38, in the drawing from the right hand side, this then being sealed with the cover 82. The cover 82 fixes the shaft 86 in an axial direction with the external ring of the roller bearing 88.

A sensor PCB (not illustrated in FIG. 2) can be pre-mounted on the cover 82 with Hall elements or other sensors for recording the rotary position and rotational speed of the rotor 22. A magnetic disk 50 is mounted on the first shaft end 40 of the rotor 22 for this purpose in the embodiment in FIG. 1. It transmits commutation signals through the wall of the cover 82 to the sensor PCB.

The roller bearing 46, preferably a ball bearing, aids accurate centering of the motor on the pump housing 10. This ball bearing 46 can assume both the motor support and pump support functions. The same applies to the ball bearing 46 in accordance with FIG. 1, but the second bearing in FIG. 1 is designed as a journal bearing 48.

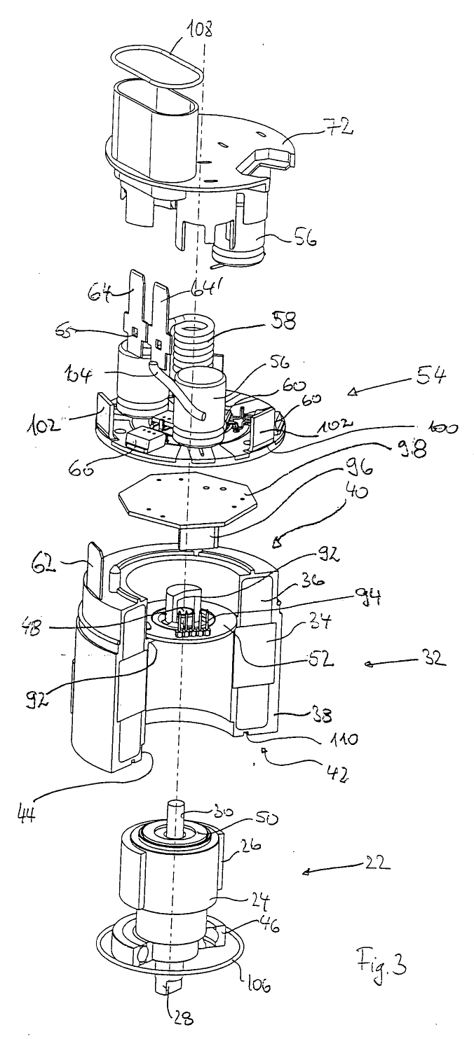

FIG. 3 illustrates a dismantled perspective view of the electric motor of FIG. 1 according to the present invention. The same or similar components are designated with the same reference numbers. FIG. 3 illustrates a general view of the rotor 22, stator 32, the electronic module 54 and the supporting part 72, already described with reference to FIG. 1. It can be seen in FIG. 3 that the plastic body 38 forms a chamber closed on one side for receiving the rotor 22, this chamber being closed by a wall 92 at the first shaft end 40 which is shaped to receive the shaft stub end 30 and journal bearing sleeve 48. The sensor PCB 52 is fitted to the wall 92 (which supports connection pins 94). The connection pins 94 can be connected to a plug 96 which connects the sensors on the sensor PCB 52 with the other components in the electronic module 54. The electronic module 54 can, as illustrated in FIG. 1, be mounted on a single PCB or several levels (or two PCB's 98, 100). The transistors 60 can be arranged and connected so that their connection legs penetrate at least in part the upper PCB 100 and can be directly connected to the lower PCB 98. Reference is made to the German patent application 102 39 512.8 of 28 Aug. 2002 with regard to the structure of the electronic module.

In a preferred embodiment, the connection pins 62 directly connected to the phase windings 36 of the stators 32 are connected to the electronic module 54 by metal lugs 102. The metal lugs 102 and connection pins 62 are pressed against the cover after assembling the different electric motor 20 components and can be attached with a welding tongs.

The electronic module 54 (or parts thereof) could be fitted outside the electric motor in an alternative embodiment. The sensors on the sensor PCB 52 and the electronic module 54 could also be combined.

The invention is ideally intended for use with a completely sealed electric motor which contains the electronics required for motor control, so that only power supply connections in the form of connection pins 64, 64′ protrude to the exterior. The positive supply connection 64 should be connected directly to the interference suppresser 58 in the embodiment illustrated, creating a mechanical spring support of the connection pin 64 which facilitates insertion of the connection pin 64 in the supporting component 72. The interference suppressor 54 therefore has a mechanical support function in addition to its electrical function, allowing a degree of movement of the connection pin 64. The other, negative supply connection 64′ can be coupled with one of the metal lugs 102 via a cable length 104 to connect the phases 36 of the stators 32. Both connection pins 64 and 64′ have openings 65 which interact with the corresponding engaging elements (not illustrated) in the supporting component 72.

It is, of course, also possible to connect other leads for electric motor control from outside with the electronic module 54 and lead these towards the outside.

In addition to the representation in FIG. 1, FIG. 3 shows O-rings 106, 108 for sealing the roller bearing 46 against the plastic body 38 or the supporting component 72 against the cover 66. Moreover, a groove 110 is illustrated on the second shaft end 42 of the plastic body 38 for receiving the O-ring 70.

The components in the electronic module 54 are connected via the metal tabs 102 and other metal rails fitted to the PCB 100, as shown on the embodiment illustrated in FIG. 3. These PCB tracks can be realized as lead frames or as individual connection elements.

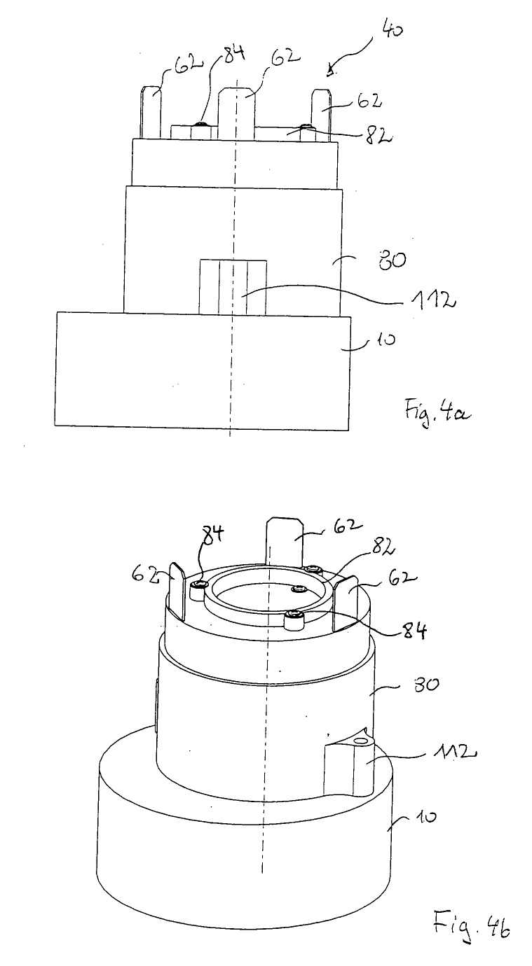

FIGS. 4A and 4B show a side view and a perspective representation, respectively, of the plastic body 80 mounted on the pump housing 10. Only the connection pins 62 for the three phase required for the phase windings 36 of the stator 32 protrude from the plastic body 80, as illustrated in FIGS. 4A and 4B. The embodiment illustrated in FIGS. 4A, 4B corresponds with the drawing in FIG. 2, so that the plastic body 80 is closed at the first shaft end 40 by the cover 82. The cover 82 is fitted to the plastic body 80 with screws 84. FIGS. 4A, 4B also illustrate that the plastic body 80 is shaped with fixing agent 12 to form a flange to connect the plastic body 80 directly to the pump housing 10.

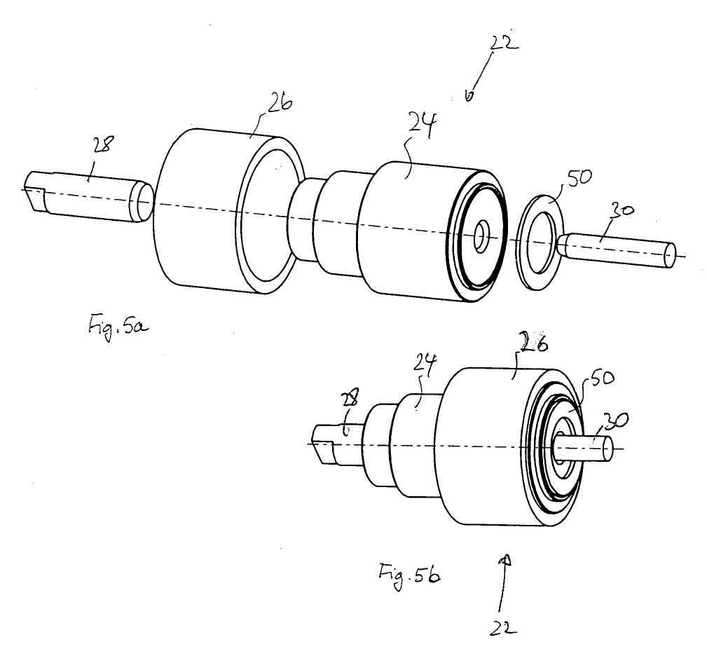

FIGS. 5A, 5B show the rotor 22 of the electric motor in FIG. 1 in both a dismantled view and an overall perspective view, respectively. Identical or similar components as in FIG. 1 are designated with the same identification reference.

The invention is used in particular as a power for the auxiliary hydraulic steering assistance in vehicles, but is, in principle, suitable for use as a pump motor or as a wet-rotor motor for a variety of applications.

The characteristics disclosed in the above description, claims and the drawings can be significant for the realization of the invention, either individually or in any combination whatsoever.

### Identification Reference List

10 Pump housing

20 Electrical motor

22 Rotor

24 Coil flux guide, yoke

26 Permanent magnet

28, 30 Shaft stub end

32 Stator

34 Stator component

36 Phase winding

38 Plastic body

40 First shaft end

42 Second shaft end

44 Bearing seat

46 Roller bearing

48 Journal bearing sleeve

50 Magnetic disk

52 Sensor PCB

54 Electronic module

56 Buffer capacitor

58 Interference suppressor

60 FET power transistor

62, 64, 64′ Connection pins

65 Outlet

66 Cover

68, 70 O-ring

72 Supporting component

74 O-ring

80 Plastic element

82 Cap

84 Screw

86 Shaft

88 Roller bearing

90 O-ring

92 Wall

94 Connecting pins

96 Plug

98, 100 PCB's

102 Metal lugs

104 Cable piece

106, 108 O-rings

110 Slot

112 Fixing agent

1. Electric motor for a pump drive, including a stator and a rotor for driving a pump impeller, the stator being embedded in a plastic body and the plastic body forming a chamber together with the stator in which the rotor is received, the chamber being closed at one shaft end of the rotor and the rotor being connected at the opposite second shaft end to the pump impeller.

2. Electric motor according to claim 1, wherein the plastic body is manufactured by injection molding.

3. Electric motor according to claim 1, wherein the plastic body which surrounds the stator forms a chamber closed at the first shaft end, integrally formed in one molding procedure.

4. Electric motor according to claim 1, wherein the plastic body which surrounds the stator forms a chamber open at both shaft ends which is closed with a cover at the first shaft end.

5. Electric motor according to claim 3, wherein a bearing seat for receiving a roller bearing to support the rotor is integrated in an interior wall of the chamber at the second shaft end.

6. Electric motor according to claim 4, wherein a bearing seat for receiving a roller bearing to support the rotor is integrated in an interior wall of the chamber at the second shaft end.

7. Electric motor according to claim 3, wherein the rotor is fitted on a shaft which is supported by a journal bearing at the first shaft end.

8. Electric motor according to claim 4, wherein the rotor is fitted on a shaft which is supported by a journal bearing at the first shaft end.

9. Electric motor according to claim 1, wherein the rotor is equipped with a coil flux guide connected to shaft stub ends at both shaft ends.

10. Electric motor according to claim 1, wherein the stator has a stator core and phase windings, each connected to a connection element for each phase, the plastic body surrounding the wound stator in a manner which allows only the connection element to be accessible.

11. Electric motor according to claim 8, wherein the rotor received in the chamber when operating the electrical motor in connection with a pump is immersed in the pumping medium.

12. Electric motor according to claim 8, characterized by an electronic module for electrical motor actuation which is located outside the chamber.

13. Electric motor according to claim 10, wherein the electronic module is separated from the pumping medium by the plastic body.

14. Electric motor according to claim 10, wherein the connection element for each phase of the electrical motor has a contact lug, and the electronic module has suitable contact lugs, these coming to rest next to the connection element contact lugs for connection thereof.

15. Electric motor according to claim 1, wherein at least part of the plastic body has metal parts integrated in it to shield the electrical motor against outside influences.
